(19) United States
(12) Patent Application Publication
(10) Pub. No.: US 2010/0277573 A1
(43) Pub. Date: Nov. 4, 2010

(54) Orthostereoscopic Motion Picture Theater

(75) Inventor: Henry Minard Morris, Venice, CA (US)

Correspondence Address: Henry Minard Morris Jr., PO Box 3024, Venice, CA, 90294, US

(73) Assignee: Mr. Henry Minard Morris, JR., Venice, CA (US)

(21) Appl. No.: 12/723,669

(22) Filed: Mar. 14, 2010

Related U.S. Application Data
(60) Provisional application No. 61/175,002, filed on May 2, 2009.

(51) Int. Cl. H04N 13/02

(52) U.S. Cl. 348/51; 348/E13.075

(57) ABSTRACT

A system for presenting stereoscopic motion pictures comprising a predominantly hemispherical screen (10) and a plurality of seats (18). The hemispherical screen comprises a north and south pole which are adjoined vertically, extending approximately 180 degrees horizontally (14B) and 180 degrees vertically (14A), and having a radius of at least 4.9 meters. The screen comprises a plurality of polygonal stereopixels (32) and a polygonal lenticular lens array (38) to accomplish autostereo. The seats are disposed within 43.2 percent orthostereo tolerance (20) in relation with sphere radial center (16), and are disposed vertically in relation with the other seats.

### CROSS-REFERENCE TO RELATED APPLICATIONS

Not Applicable

### FEDERALLY SPONSORED RESEARCH OR DEVELOPMENT

Not Applicable

### SEQUENCE LISTING OR COMPUTER PROGRAM

Not Applicable

### FIELD OF INVENTION

The present invention is in the technical field of motion picture theaters. More particularly, the present invention is in the technical field of stereoscopic, or 3-D, motion picture theaters.

### BACKGROUND OF THE INVENTION

Stereoscopic cinema has historically lived in a 30 year cycle of fads: for a few months in the 1920s, two years in the 1950s, four years in the 1980s and coming again late this first decade of the 21^{st} century. An abundance of historical evidence supports a theory that 3-D has continually failed to become a self-sustaining narrative format like the conventional 2-D cinema because of technical flaws in the way it is recorded and presented. The most significant and fundamental of these flaws are related to the concepts of, first, orthostereo: presenting 3-D motion pictures in a way that is perfectly consistent with the human visual experience, and second, full field-of-vision: filling the viewer's visual periphery (arguably one aspect of orthostereo). A perfect standard for orthostereo in theatrical exhibition has never been attempted for several reasons. These include the lack of affordability in implementing these methods (a problem that modern digital technology is solving) and the lack of a consensus by practitioners of stereoscopic motion pictures about the importance of achieving an orthostereo standard. Orthostereo ideas can be traced back to the original inventors of stereography and discoverers of stereopsis (depth perception), Sir Charles Wheatstone and Sir David Brewster, who prescribed implementation methodologies for stereoscopy in the early 1800s which were not technically achievable in that era and that have since come to be termed “orthostereo.”

There are several stereoscopic theatrical designs that are currently being used to present 3-D motion pictures. They are each flawed in a number of ways and none is capable of achieving an orthostereo standard. First, and most numerous, are conventional 2-D theaters that are retrofitted for 3-D using digital technology such as Achromatic Polarization Switches (U.S. Pat. No. 11,424,087, Michael G. Robinson, 2006). This process uses a flat screen onto which the 3-D images are projected via a single digital projector. The benefit of this design is that current theatrical infrastructure is abundant, allowing 3-D content distributors to reach a wide market. The drawbacks are that it lacks the immersion of a wide field-of-vision and it lacks orthostereo. For this discussion, the aspects of stereoscopic presentation that are inconsistent with the human visual experience, or non-orthostereo, will be referred to as “stereopsis flaws.” These include:
(1) Vertical parallax: inconsistent compositional elements in the left and right views.
(2) Retinal rivalry: the brain's resulting confusion.
(3) Enlarged horizontal parallax: straining of the viewer's eyes because of incorrect distance on screen between left and right images.
(4) Keystoning: a change in the perceived geometry of compositional elements based on projection and viewing angle.
(5) Ocular divergence: the unnatural divergence of the viewer's eyes when viewing certain compositional elements in certain circumstances.

These stereopsis flaws occur because the seating arrangement forces each viewer to be a non-uniform distance and angle to the screen, the planar screen shape means that each viewer is a non-uniform distance from every part of the screen, and the above flaws necessitate the use of non-parallel camera and projector lenses in the effort to compensate for viewer eyestrain and mental confusion. All of these stereopsis flaws taken together, the evidence suggests, have significantly contributed to 3-D cinema's historical demise.

3-D television possesses all the stereopsis flaws of conventional theaters due to its planar screen, lack of full field of vision and lack of uniform viewing distance and angle. But unlike conventional theaters, it also has one other flaw:
(6) The convergence and accommodation breakdown. In any theatrical design employing left and right flat images, there is an unavoidable incongruity between focus and convergence: the eyes converge on a point in front of or behind the screen while focusing or “accommodating” on the screen itself.

Studies have shown that this breakdown of focus and convergence is only upsetting to the brain when the eyes are focused nearby, though not when focused in the distance. This fact benefits larger viewing scenarios in which the screen is as far as possible from the viewer, while creating a fundamental perceptual flaw for smaller, closer viewing scenarios such as television and self-enclosed stereoscopic viewing goggles.

IMAX® theaters (U.S. Pat. No. 5,822,928, Ian Maxwell, 1998) have effected a great technical improvement over conventional cinemas because their screens take up a much larger portion of the viewer's field-of-vision and they provide a higher level of orthostereo accuracy. The IMAX® theatrical design's flaws reside in the fact that it was intended as a premium monoscopic, or 2-D, experience, not 3-D. Its screen is still predominantly planar and its seating varies widely in terms of distance from and angle to the screen. This means that true orthostereo is impossible. Also, it still does not completely fill the viewer's field-of-vision, meaning that full immersion is also impossible. Next, in order to achieve orthostereo, the camera lens field-of-vision must be preserved during exhibition with a complementary projection field-of-vision. IMAX® fails to achieve this standard because, just like conventional theaters, it conforms all camera lens fields-of-vision to the same sized screen.

Inventors have proposed many wide-field projection designs (up to 360 degrees field-of-vision) throughout the past century. These include the Heilig Experience Theatre (U.S. Pat. No. 3,469,837, M. L. Heilig, 1966) which has greatly influenced 3-D theme park rides, the Geodesic Dome Theater (U.S. Pat. No. 4,885,878, George Wuu, 1989), Video Based Immersive Theater (U.S. Pat. No. 6,733,136, Edward J. Lantz, 2004), the Virtual Reality Theater (U.S. Pat. No. 6,665,985, Thomas Hennes, 2003), Hayashi's Dome Theater (U.S. Pat. No. 5,611,174, Masahiko Hayashi, 1997) and the Curved Screen Projection Apparatus (U.S. Pat. No. 6,727,971, Walter A. Lucas, 2004), just to name a few. These designs employ spherical, semi-spherical, truncated and otherwise curved screens and seek to immerse the audience in the movie with an experience of visual realism. They are generally intended for monoscopic images and while stereoscopic images can be presented, as they are in some planetaria, these presentations are not intended for nor capable of achieving an orthostereo standard.

As an example, there are currently two existing 8K (digital high definition) stereoscopic theaters in the world with dome screens. They are problematic in the following ways:
They are not compatible with regular movie content: the dome is tilted so that horizon is placed at 15 degrees, meaning that the audience is looking upward and at mostly sky. This requires “full dome” content, shot with fisheye lenses, also tilted to place horizon at 15 degrees to match the screen disposition, and intended for planetarium audiences.
They are not autostereo (discussed more fully in the next paragraph). They use an image selection process which requires wide viewing angle glasses, an accessory to the viewing process that may be partly to blame for 3-D cinema's historic failure.
They use a series of high definition projectors, 16 of them, all pointing at different parts of the screen and blended together into one seamless image: expensive, difficult to maintain, and taking up a large section of vital seating area.
There is no accounting for orthostereo: their audience seating is non-uniform in distance and angle to the screen and there is no attempt to preserve field-of-vision between recording and presentation, thus leading to all the aforementioned stereopsis flaws.
   No stereoscopic theater in existence either attempts or is capable of achieving an orthostereo standard, a key element to the success and self-sustainability of 3-D motion pictures as a narrative artform and business.

Autostereoscopy is a method of displaying 3-D images that can be viewed without the use of special headgear or glasses on the part of the viewer. There exist several highly effective forms of autostereo. One such form is known as the lenticular lens array, commonly used in stereoscopic printing. The Composite Lenticular Screen Sheet (U.S. Pat. No. 4,414,316, Kenneth E. Conley, 1983) can be described as specially prepared graphics that are designed to work together with the lenticular lens sheet to allow the viewer to see different images depending on the angle at which they view it. The image itself is a composite of two or more graphics (left and right views) that are interlaced together. The lens is a unique extruded plastic that is made up of individual lenticules that must be perfectly aligned with the interlaced image underneath it in order for the effect to work. Based on the angle of the viewer, each lenticule acts as a magnifying glass to enlarge and display a portion of the image below. An array of lenticules working in harmony form the entire lenticular image. If the lenticules run vertically, a different image can be delivered to each eye to create a 3-D image. In this way, lenticular print can show depth because each eye is viewing the lenticular print from its own angle.

However, such autostereo methods have never been useful in movie theaters because:
They require a strictly uniform distance and angle between the viewer and screen, which conventional theaters cannot provide.
They usually require extraordinarily high screen resolution, an expensive proposition prior to the advent of modern high definition digital technology.
The process of splitting off a path of light into two separate paths usually causes a significant reduction of the light's intensity for each path, requiring extraordinarily large amounts of light, also an expensive proposition.
   If it were possible to address each of these issues with the use of modern digital technologies and with the design of the theater itself, autostereo could be a reasonable and affordable possibility for motion picture theaters.

### BRIEF SUMMARY OF THE INVENTION

The present invention is a stereoscopic motion picture theater. In recognizing the technical and economic flaws that have lead to the 3-D motion picture industry's constant historical failure, the invention's primary purpose is to correct those flaws with a design specifically intended to achieve an orthostereo 3-D standard. This contrasts with the current 3-D venues that were designed for 2-D movies, then retrofitted for 3-D, such as conventional theaters, 3-D TV and IMAX®. Of primary concern are the specific shape, size, dimensions and spatial relationship of the screen and audience seating, the consistency of field-of-vision between recording and presentation, and autostereo capability: the lack of need for special 3-D eyewear.

### DRAWINGS—FIGURES

In the drawings, closely related figures have the same number but different alphabetic suffixes.

FIG. 1 is a perspective view of one embodiment of the orthostereoscopic theater.

FIG. 2 is a an exploded view of one embodiment of the polygonal lenticular lens array autostereo.

FIG. 3 is a top view of one embodiment of the polygonal lenticular lens array autostereo.

FIG. 4 is a perspective view comparing the cubic space requirements for conventional theaters with that of the preferred embodiment of the orthostereoscopic theater.

### DESCRIPTION OF THE PREFERRED EMBODIMENTS

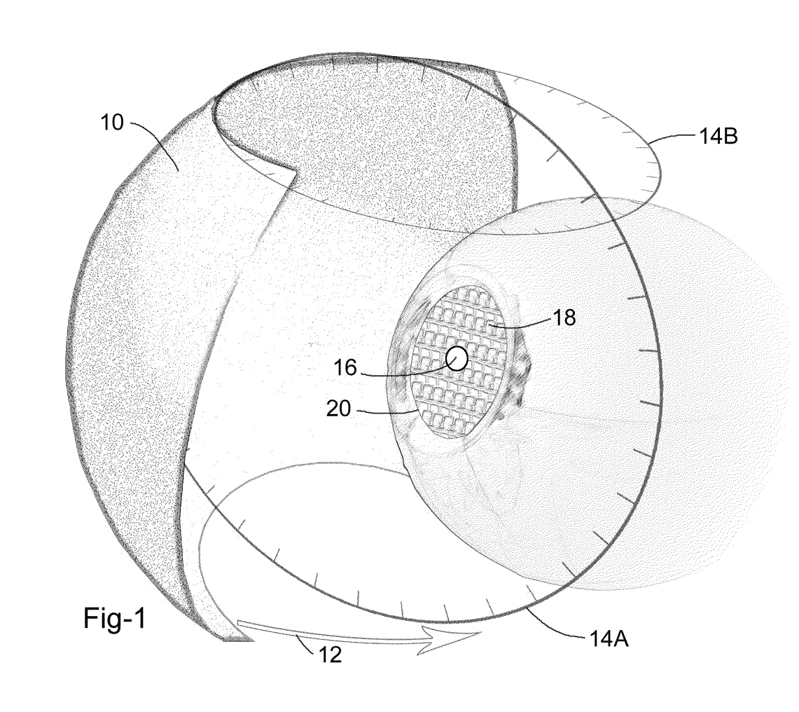

Referring now to the embodiment in more detail, in FIG. 1 there is shown a hemispherical or dome screen 10, on which wide field-of-vision images are presented that wrap around viewers to the limits of the adjacent seating, approximately 180 degrees horizontally 14B and 180 degrees vertically 14A. A prime view point or sphere radial center 16 is the point in space relative to the screen 10 where a theoretically perfect orthostereo condition exists. That is, the images on screen are undistorted and recreate the human visual experience perfectly. An orthostereo tolerance 20 is the volumetric space outside of the sphere radial center 16 where orthostereo is not perfect, but the stereopsis flaws (as defined in the previous section) are so minor that they are neither perceivable nor distracting to the viewer. The orthostereo tolerance 20 is defined as 43.2 percent of the dome radius for domes larger than ten meters in diameter. For example, given a dome screen with a diameter of twenty meters, seating may be placed no farther than 4.32 meters along the x, y and z axes from radial center 16.

In further detail, still referring to the embodiment of FIG. 1, audience seating is arranged in a predominantly vertical fashion 14 and in single rows with no one in front of or behind anyone else, only beside, above and below. This is the preferred embodiment, though other embodiments may include any seating arrangement so long as the orthostereo tolerance boundaries 20 are maintained.

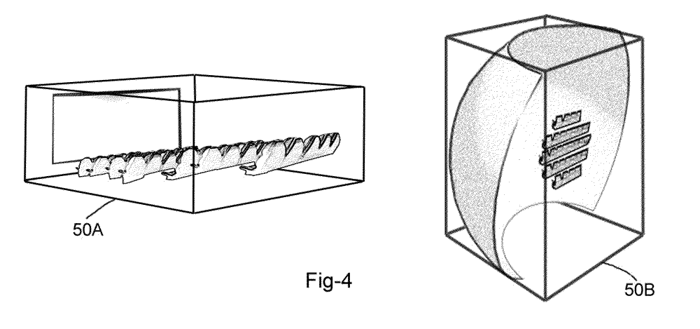

When placing the screen in its correct position according to the arrow 12, it becomes apparent that the required venue space is tall and narrow. Referring to the embodiment of FIG. 4, the venue space required to accommodate 100 people for conventional cinemas 50A is approximately 102,900 cubic feet, and the space requirement for the embodiment 50B is approximately 59,400 cubic feet.

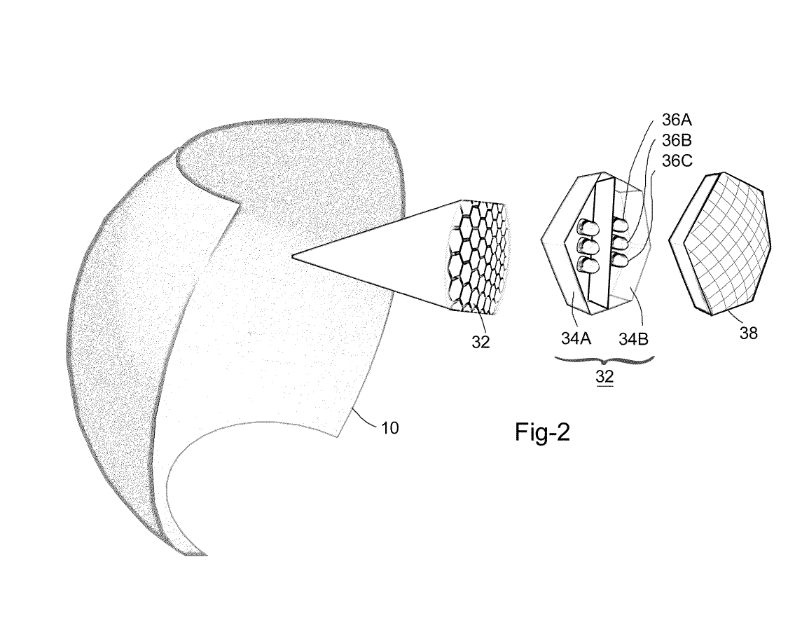

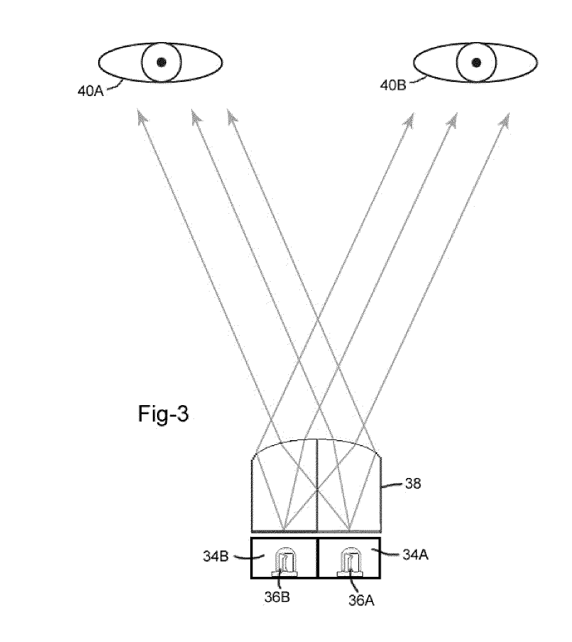

Referring now to FIGS. 2 and 3, there is shown the preferred embodiment of a polygonal lenticular lens array. FIG. 1 shows an exploded view and FIG. 2 shows a top view. The term “image selection” refers to the process of channeling a left view image into a left eye 40B (without being seen by the right eye) and a right view image into a right eye 40A (without being seen by the left eye). The term “autostereo,” as previously discussed, refers to an image selection means that does not require eyewear. The embodiment uses hexagonal stereopixels 32 arranged in a beehive honeycomb fashion, each composed of two compartments, or subpixels, one for the right image pixel 34A and one for the left image pixel 34B. These compartments contain light emitting diodes (LED) 36, one each for colors red 36A, green 36B, and blue 36C, thus reproducing the entire color spectrum. A hexagonal lenticular lens 38, having the same size and shape as the stereopixel 32 is placed in front of the stereopixel 32, refracting the light from each subpixel 34 in slightly different directions so that they may be channeled into the corresponding left 40B and right 40A eye of the viewer. The lenticular lens 38 focal length calibration depends on the viewing distance of a given sphere size. To achieve a seamless image in which the individual stereopixel 32 and lenticular lens 38 cannot be seen by the naked eye, it must take up no more than 0.0227 degrees of viewing angle. So, this embodiment requires a standard resolution of about 8,000 stereopixels across the longest screen circumference.

This is the preferred embodiment of the polygonal lenticular lens array autostereo method because it holds the highest potential for image quality and image selection effectiveness. However, a number of alternative embodiments are possible including the use of other screen illumination technologies such as organic light emitting diodes (OLED) and front projection. Also, while hexagonal pixels would appear to strike the best compromise between quality and affordability, any polygonal pixel shape is possible as long as the lenticular lens array conforms in size and shape to each individual stereopixel.

### Advantages

Referring to the embodiment of FIG. 1, audience seating 14 is of a predominantly vertical fashion, and in a single row, for two main reasons. First, it allows each viewer an unobstructed view of the entire 180 degree motion picture field-of-vision. And second, it provides a means of obstructing each moviegoer's view of the edge of the screen because that view ends at the other moviegoers beside, above and below them. This creates a diegetic end to the visible image, as opposed to the abrupt frame edge of a conventional rectangular movie screen. This is described as “diegetic” because adjacent moviegoers do more than create a natural end to the visible image, they seem to be present and included within the fictional world of the movie. Both of these functions more accurately recreate the human visual experience and help create a more natural sense of presence, the feeling that they and their fellow viewers occupy the same physical space as the one represented by the motion picture they are viewing.

Still referring to the embodiment of FIG. 1, the field-of-vision limits, approximately 180 degrees horizontally 14B and 180 degrees vertically 14A, have several implications. First, they are a means of providing the capability of presenting images with the equivalent field-of-vision of their recording means, up to approximately 180 degrees. Next, the audience is seated and facing forward, instead of standing. This follows a proven conventional cinema business model, limiting the field-of-vision to what image is in front of the viewer, rather than completely surrounding them by up to 360 degrees. This also allows the embodiment to be compatible with current content production techniques and formats—any 3-D movie produced by the conventional production methods of the motion picture industry will be presentable without the need for specialized complimentary wide field-of-vision recording equipment, as would be the case with a 360 degree screen or tilted dome.

Maintaining these boundaries of orthostereo tolerance 20, the viewer perceives no stereopsis flaws. These flaws are present in all current 3-D exhibition venues. These flaws include (as defined previously) vertical parallax, retinal rivalry, horizontal parallax, keystoning, ocular divergence, and the convergence/accommodation breakdown. Further, this removes visual discomfort and distraction, and precisely recreates depth and scale so that the viewer sees the visual scene exactly as if they were standing in place of the camera.

The embodiment of FIG. 4 compares the cubic space requirements for conventional theaters with that of the preferred embodiment of the orthostereoscopic theater. The venue space required to accommodate 100 people for conventional cinemas 50A is approximately 102,900 cubic feet. The space requirement for the embodiment 50B is approximately 59,400 cubic feet. This allows the embodiment to follow a conventional cinema business model, not possible for any other wide field-of-vision 3-D exhibition format, including IMAX®. This carries profound implications given that the motion picture industry's reluctance to move toward an orthostereo standard is partially due to its historic lack of economic viability.

As previously discussed, the achievement of an orthostereo standard requires that the camera lens field-of-vision be preserved during presentation. A conforming process for this field-of-vision preservation is not within the scope of this document. However, it is relevant because the invention is designed to be future proof or “forward compatible” with such a conforming process due to its wide field-of-vision and uniform viewing distance and angle. This cannot be said of any current stereoscopic presentation method including retrofitted conventional theaters, 3-D TV or IMAX® theaters.

### Conclusion, Ramifications, and Scope

The present embodiments include, without limitation, a comprehensive effort to address all the technical and economic flaws that have lead to the 3-D motion picture industry's historical failure. One of the reasons that the 3-D movie industry has consistently failed to become self-sustaining throughout history is that it has never before been possible to provide audiences with an orthostereoscopic methodology in a way that is economically viable. These embodiments attempt to make that possible.

Venue space requirements allow a multiplex theater (as opposed to IMAX® and tilted domes) business model, creating the potential for multiple screens in a relatively small volumetric space. Theatrical infrastructure can be expanded affordably, and all the benefits of conventional cinemas will apply, including abundant content choice, scheduling convenience, greater operational flexibility, and economies of scale.

The embodiment differs from a conventional theater in which the 3-D image has a false depth and scale and myriad perceptual distortions and stereopsis flaws caused by broken orthostereo. These differences include:
The embodiment allows a uniform distance between all viewers and every part of the screen (within the orthostereo tolerance).
It allows a uniform angle between all viewers and every part of the screen.
It allows a forward-compatible capability for field-of-vision preservation between recording and presentation.
It eliminates all stereopsis flaws including vertical parallax, retinal rivalry, horizontal parallax, keystoning, ocular divergence and the convergence/accommodation breakdown. These flaws are present in all current stereoscopic theaters and presentation formats.
   And it differs from hemispherical or dome theater designs in the following ways:
It spatially and qualitatively defines a set of orthostereo parameters and then conforms viewing to those requirements.
It requires no specialized recording techniques or equipment.
It is compatible with conventional 3-D motion picture content produced by the main stream movie industry.

These differences allow the viewer to experience an immersive, non-distracting and visually flawless stereoscopic motion picture, as though they were physically present in the world represented by the movie, while at the same time attempting economic viability by availing itself to all the advantages of the proven business model of conventional theaters.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A system for presenting stereoscopic motion pictures comprising a predominantly hemispherical screen and a plurality of seats; said hemispherical screen comprising a north and south pole which are adjoined vertically; said hemispherical screen extending approximately 180 degrees horizontally and approximately 180 degrees vertically; said hemispherical screen having a radius of at least 4.9 meters; and said seats being disposed within orthostereo tolerance, defined as 43.2 percent of said hemispherical screen radius in relation with sphere radial center.

2. The system of claim 1 wherein said seats are disposed vertically in relation with the other seats.

3. A system for presenting stereoscopic motion pictures comprising a predominantly hemispherical screen and a plurality of seats.

4. The system of claim 3 wherein said hemispherical screen extends approximately 180 degrees horizontally and approximately 180 degrees vertically as a means of filling the viewer's entire peripheral vision, and as a means of providing the capability of presenting images with the equivalent field-of-vision of their recording means, up to approximately 180 degrees.

5. The system of claim 3 wherein said hemispherical screen has a radius of at least 4.9 meters as a means of creating enough viewing distance to prevent the flaw of orthostereo known as the convergence and accommodation breakdown.

6. The system of claim 3 wherein said hemispherical screen comprises a north and south pole which are adjoined vertically.

7. The system of claim 3 wherein said seats are confined to an orthostereo tolerance, defined as a boundary surrounding the sphere radial center that lies 43.2 percent of the sphere radius away from sphere radial center on x, y, and z axes, whereby said orthostereo tolerance provides a means for maintaining a uniform distance between all viewers and every part of the screen, thereby removing a plurality of causes of broken orthostereo from the stereoscopic viewing experience including vertical parallax, retinal rivalry, horizontal parallax, keystoning, and ocular divergence.

8. The system of claim 3 wherein said seats are of a predominantly vertical disposition as a means of obstructing each viewer's sight of the edge of the screen, so that the adjacent viewers and seats beside, above and below each viewer create a diegetic end to the visible image rather than the frame edge of a conventional movie theater, thereby creating a more natural sense of presence in the volumetric world represented by the motion picture.

9. A screen for presenting stereoscopic motion pictures without eyewear; said screen comprising a plurality of polygonal stereopixels and a lenticular lens array.

10. The screen of claim 9 wherein said screen is in the shape of a hemisphere.

11. The screen of claim 9 wherein said polygonal stereopixels are arranged in a beehive honeycomb fashion.

12. The screen of claim 9 wherein said polygonal stereopixels are disposed at no more than 0.0227 degrees of viewing angle as measured from closest said seats to the screen.

13. The screen of claim 9 wherein said polygonal stereopixels comprise a left and right subpixel, said subpixels being compartmentalized from each other.

14. The screen of claim 9 wherein said lenticular lens has the same size and shape as said polygonal stereopixel and is disposed in front of said polygonal stereopixel, the lenticular lens being shaped to refract light along two divergent paths.
